(19) United States
(12) Patent Application Publication
(10) Pub. No.: US 2003/0184158 A1
(43) Pub. Date: Oct. 2, 2003

(54) Method for operating a distributed safety-relevant system

(76) Inventor: Thomas Fuehrer, Gerlingen (DE)

Correspondence Address: KENYON & KENYON, ONE BROADWAY, NEW YORK, NY, 10004, US

(21) Appl. No.: 10/276,816

(22) PCT Filed: Mar. 14, 2002
(86) PCT No.: PCT/DE02/00915

(30) Foreign Application Priority Data
Mar. 15, 2001 (DE) 101 12 911.4

(51) Int. Cl. B60L 1/00; B60L 3/00

(52) U.S. Cl. 307/10.1

(57) ABSTRACT

A method of operating a distributed safety-related system, [in particular] i.e., an X-by-wire system in a motor vehicle, is described. The distributed system includes at least one first process computer [(Pro_{—}1)] for triggering a component [(Akt_{—}1)] of the system and at least one additional process computer[(Pro_m)]. The process computers [(Pro_{—}1, Pro_m)] are each connected to a communication system [(K_{—}1)] via a communications controller[(S_{—}1, S_m)]. The functionality of the at least one first process computer [(Pro_{—}1)] is checked by the at least one additional process computer [(Pro_m)]. This method is also [known] referred to as a distributed monitoring concept. A mechanism for secured shutdown of at least one faulty first process computer [(Pro_{—}1)] by at least one of the additional process computers [(Pro_{—}1) is described] is provided, by which a communication protocol of the communication system [(K_{—}1)] is supplemented for implementation of the distributed monitoring concept.

### BACKGROUND INFORMATION

The present invention relates to a method for operating a distributed safety-related system, in particular an X-by-wire system in a motor vehicle. The distributed system includes at least one first process computer for triggering a component of the system and at least one additional process computer, the process computers each being connected to a communication system via a communications controller. The functionality of the at least one first process computer is checked by the at least one additional process computer.

The present invention also relates to a distributed safety-related system, in particular an X-by-wire system in a motor vehicle. The distributed system includes at least one first process computer for triggering a component of the system and at least one additional process computer, the process computers each being connected to a communication system via a communications controller. Monitoring of the functionality of the at least one first process computer is performed by the at least one additional process computer.

In addition, the present invention relates to a communications controller for connecting at least one first process computer and at least one additional process computer to a communication system of a distributed safety-related system, in particular an X-by-wire system in a motor vehicle. The at least one first process computer is used for triggering a component of the distributed system. A communication protocol runs on the communications controller for implementing a data transfer between the process computers and the communication system.

Finally, the present invention also relates to a communication protocol for a communication system of a distributed safety-related system, in particular an X-by-wire system in a motor vehicle. The distributed system includes at least one first process computer for triggering a component of the distributed system and at least one additional process computer. The process computers are each connected to the communication system via a communications controller. The communication protocol for implementing a data transfer between the process computers and the communication system runs on the communications controllers.

Networking of control units (process computers), sensors, and actuators with the help of a communication system in the automotive field has increased greatly in recent years. The possibility of a mutual influence of the process computers via the communication system must be ruled out. Of main concern are synergism effects due to the distribution of functions among multiple process computers. These are called distributed systems.

X-by-wire systems are a special embodiment of such distributed systems. An X-by-wire system is a motor vehicle system which is used in movement of the vehicle and for input of the determination of the driver's intent and its implementation. The connection between the determination of the driver's intent and its implementation is not mechanical, but instead is based essentially only on (electronic) information transfer. An X-by-wire system is a system having high safety requirements, i.e., a complete failure of this system generates a fault of the highest possible safety level in the motor vehicle. Three classes of such systems are considered.

1. Wet X-by-wire systems are systems having a hydraulic (mechanical) fall-back level which is capable of maintaining the basic functionality even without an electric power supply (e.g., after failure of the power supply). The term basic functionality is understood to refer to the function which would still be present with a fixed mechanical coupling of driver's intent to effect achieved. In the case of a motor vehicle brake, for example, the basic brake function is the brake function without an electronic regulating system which could generate a variable braking force distribution. In the case of the basic brake function, it is fixedly predetermined then (depending on the system) that, for example, 65% of the braking force is for the front axle and 35% for the rear axle. Anti-lock brake systems (ABS), traction control systems (TCS), and vehicle dynamics control systems are not part of the basic brake function.

2. Dry X-by-wire systems are systems without a mechanical/hydraulic fall-back level. Implementation is based exclusively on electromechanical components.

3. Semi-dry X-by-wire systems are systems which have a hydraulic actuator but also have a “dry interface.” With respect to the communication requirements, these systems are therefore to be handled in the same way as dry X-by-wire systems.

Typical examples of X-by-wire systems include steer-by-wire and brake-by-wire systems (electronic steering and electronic brakes).

In all systems with high safety requirements, in particular in X-by-wire systems, mechanisms are needed to enable the actuators, e.g., electric motors or hydraulic pumps. In the related art, this is implemented by “intelligent watchdogs” based on a question-and-answer communication.

A method of the type defined in the preamble is known for example from German Patent Application 198 26 131 A1. This publication describes a distributed safety-related system as an electric brake system in a motor vehicle. The components are designed as the brakes of the motor vehicle, i.e., more precisely, as actuators for triggering the brakes. Such a system is extremely safety-related, because faulty triggering of the components, in particular faulty actuation of the brakes, may result in an unforeseeable safety risk. For this reason, the possibility of faulty triggering of the components must be ruled out reliably.

Essential features of the known brake system include a pedal module for central determination of the driver's intent, four wheel modules for wheel-individualized regulation of the brake actuators, and a processing module for calculating higher-level brake functions. Communication among individual modules may take place through one or more communication systems. FIG. 2 of the present patent application shows the internal structure of a wheel module having various logic levels as an example. Logic level L1 includes at least the calculation of the control and regulating functions for the wheel brakes, while logic levels L2 through L4 include different functions for computer monitoring and function testing of L1.

Triggering of the brakes, i.e., the electric motors for actuating the brake shoes, includes the following steps for each wheel module equally:

a) Determining at least one triggering signal (f_1) for the brake by a first microcomputer system (R_1A) as a function of at least one input signal (a_R2, a_R3, a_R4; a_V, ref; s_R2, s_R3, s_R4; Δs_V, ref; v_F; n_1; d_1 F_1i; a_Ri; s_R1). The input signals are made available to the microcomputer system (R_1A) via a communication system (K_1), e.g., a bus system.

b) Determining at least one logic triggering signal (e_1H). The logic triggering signal (e_1H) is determined at least partially by a monitoring unit (R_1B), which is independent of the first microcomputer system (R_1A), as a function of the at least one input signal.

c) Comparing the at least one triggering signal (f_1) with the at least one logic triggering signal (e_1H) in a power electronics unit (LE_1K).

d) Determining at least one enabling signal (within the power electronics LE) as a function of the result of the comparison of the triggering signal (f_1) and the logic triggering signal (e_1H); and

e) Relaying the at least one triggering signal (f_1) or a signal (i_1K) which depends on the triggering signal (f_1) to the brake, i.e., to an actuator Akt_1 for the brake shoes if the at least one enabling signal has a preselectable value.

The monitoring unit (R_1B) in particular detects systematic (common mode) faults. One example of such a fault is a fault in the power supply. With the known brake system, the monitoring unit (R_1B) is designed as an independent microcomputer system. As an alternative, however, the monitoring unit (R_1B) may also be designed as a hardware module without its own processor, so that it is capable of executing concrete logic functions or, if it has a register, it may even execute switching functions. An example of such a hardware module is, for example, an ASIC (applied specific integrated circuit), an FPGA (field-programmable gate array), or a monitoring circuit (watchdog).

The control unit (microcomputer system or process computer) responsible for triggering the component (actuator) is monitored and, in the event of a fault, it is shut down by the monitoring unit. This monitoring is based on a question-and-answer communication which must follow a fixed protocol.

Enabling of the actuators (LE2R) is performed exclusively when there is a correspondence (question-and-answer communication functioning as specified) between the microcomputer system (R_1A) and the independent monitoring unit (R_1B). The principle of this enabling is based on an electric enabling circuit (AND link) implemented between the process computer and the monitoring unit. This means that both units must set a logic “one” on the enabling circuit for normal functioning of the actuators.

The actuators are shut down as soon as a process in the microcomputer system (R_1A) gives the signal for shutdown. The monitoring component (R_1B) will then give the signal for shutdown only when the monitored unit (microcomputer system R_1A) has been recognized as fault-free.

However, monitoring mechanisms for control units (process computers) which go beyond the scope of a question-and-answer communication are also needed in safety-related systems. This plays a major role in fail-silent computers in particular. By definition, these computers may give out a value to the outside only if it is correct (at the correct time) or if it is obviously represented incorrectly. Therefore, monitoring functions running locally (memory tests, plausibility checks) are implemented on the process computer itself. For highly safety-related functions, however, it is necessary to take into account the case when the fail-silent computer no longer fulfills the expected reliability. The computer is unable to shut itself down or initiate a restart. An independent unit must assume the secured shutdown or initiate a restart.

It has now become standard for virtually all manufacturers to use communication systems in the automotive area. The Society for Automotive Engineering (SAE) has defined three different classes of requirements of communication: classes A, B, and C. These classes differ in the amount of information exchanged up to the various realtime requirements and applications. The protocol class having the highest requirements is class C. An SAE specification “Communication Protocols for Class C Applications,” SAE J2056/1, June 1993 is available in this regard. This class C is the class that covers X-by-wire systems.

Communication systems which may be used for X-by-wire applications operate according to, for example, the CAN, the TTCAN(time-triggered CAN), the TTP/C, or the FlexRay protocol. The membership service is an important service in such protocols for the present invention. In this system, the membership/activity of a communication member (microcomputer system or process computer) is determined in a decision-making operation involving all the active communication members via a mechanism of message confirmation. The information regarding the membership/activity of the communication members is stored as membership information. After a certain number of decision-making rounds, the membership information is stable, i.e., is recognized as valid by all members. If a member is designated as inactive on the basis of this decision, this node must no longer be involved actively in communication. The process computer responsible for this node recognizes the inactive state and must take measures to switch its communications controller to active again (restart and resynchronization). The mechanism for determining the members is executed on an ongoing basis and is part of the actual communication protocol.

One disadvantage of the related art derived from German Patent Application 198 26 131 A1 is that logic level L4 is always implemented in a separate component, which must also be provided multiple times within the distributed safety-related system—e.g., in wheel modules of an electric brake system.

To eliminate this disadvantage, it is proposed that the monitoring unit be omitted entirely and that the functions of the monitoring unit be transferred to the at least one additional process computer of the distributed safety-related system and/or at least one of the communications controllers via which the additional process computers are connected to the communication system.

The object of the present invention is to create possibilities in such a distributed monitoring concept by which the basic functionality of a communication system, i.e., a communication protocol, namely secured message transmission, sending of messages which are directed simultaneously at multiple destinations in the communication system (multicasting), message confirmation, and the member service—e.g., in TTP/C (time-triggered protocol for class C) or CAN (controller area network), is supplemented by a mechanism for secured shutdown of process computers via the communication system.

To achieve this object, the present invention proposes, starting from a method of the type defined in the preamble, a method having the following steps:

at least one of the additional process computers which has detected a fault in at least one of the first process computers relays a triggering message via the communication system for triggering the faulty first process computer or the component triggered by it;

a check is performed to determine whether the sender of the triggering message is authorized to trigger the faulty first process computer;

a check is performed to determine whether the sender of the triggering message is connected to the communication system and is actively involved in communication via the communication system;

a decision is made according to a preselectable decision-making algorithm as to how the faulty first process computer and/or the component are to be triggered as a function of the content of triggering messages of those senders that are authorized to trigger the faulty first process computer and are connected to the communication system and are actively involved in communication via the communication system; and

the faulty first process computer and/or the component are triggered accordingly.

### ADVANTAGES OF THE INVENTION

Thus, locally or globally available information is provided according to the present invention by which a secure and reliable implementation of the distributed monitoring concept may be achieved within the communication system. For the first process computers, this information pertains to a local list in which those additional process computers that may trigger (e.g., shut down) the particular first process computer in the event of a fault are listed. In addition, the information also pertains to a global list in which those process computers that are connected to the communication system and are actively involved in communication via the communication system are listed. For example, the membership information of the member services may be used for this list. Finally, the information for each additional process computer concerns a globally available list which lists those first process computers that are recognized as faulty by the particular additional process computer and which it would therefore like to trigger (e.g., shut down).

The present invention relates to a communication system having a plurality of process computers. The process computers are divided into two groups, namely first process computers which are monitored and additional process computers which monitor. Which of the process computers of the distributed system belong to the first group and which belong to the second group is a question of definition. It is quite conceivable for one and the same process computer to belong to the first group because it is monitored by one or more of the additional process computers, and also to belong to the second group because it monitors one or more other (first) process computers.

The basic functionality of a communication system or a communication protocol, namely secured message transfer, multi-casting, message confirmation, and member service are expanded by the present invention with a mechanism for secured shutdown of process computers via the communication system. The communication system here replaces the shutdown paths which are implemented in the hardware in the related art (e.g., by cabling) (e.g., monitoring unit with star-connected cabling to wheel computers in a brake-by-wire system). The communication system permits a locally implemented, intelligent watchdog (often in the form of simple hardware circuits) according to the related art on the process computer of the control unit to be shifted to any selected process computer in the communication system. A control unit already present in the distributed system together with its process computer is preferably used. An expanded watchdog functionality, e.g., plausibility checking by counter-computing, may thus be implemented in a simpler manner.

The additional mechanism for secured shutdown in the communication system, however, also permits a distributed monitoring concept. This means that not only one process computer assumes the function of the intelligent watchdog, but instead a plurality of control units together with their process computers may cause a triggering, i.e., shutdown, via the communication system.

A communication system that has already been standardized in motor vehicles today and a bus cabling (single-wire or two-wire line) connected to it are used as the shutdown path. No explicit cabling is needed for the shutdown path between the units of the communication system. The communication system executes a triggering, i.e., shutdown, protocol which is built into the normal protocol sequence (actual sending and receiving of messages, message confirmation, and membership service). This results in a slight increased burden on the communications controller but it yields a significant improvement in the use of existing control units (process computers). In addition, the communication system makes available software and hardware interfaces to the process computer to initiate and/or implement the triggering, i.e., shutdown, protocol.

An enabling circuit by which one component (the actuator) of a distributed safety-related system is triggered by the method according to the present invention is thus operated by a process computer and by a communications controller. It is thus possible to trigger, i.e., shut down, the component via the communication system. In addition, the process computer itself may be linked to the communications controller so that the process computer which triggers the component may itself be triggered, i.e., shut down, e.g., by connecting the communications controller to a reset line of the process computer.

According to an advantageous refinement of the present invention, it is proposed that shutdown of the faulty first process computer and/or the component triggered by that computer be achieved through the triggering message.

According to a preferred embodiment of the present invention, it is proposed that a local authorization list be provided in the communications controller of the at least one first process computer on the basis of which a check is performed to determine whether the sender of the triggering message is authorized to trigger the faulty first process computer by comparing an identifier of the sender of the triggering message with the content of the authorization list.

According to another preferred embodiment of the present invention, it is proposed that a global membership list be provided in the communication system on the basis of which a check is performed to determine whether the sender of the triggering message is connected to the communication system and is actively involved in communication via the communication system by comparing an identifier of the sender of the triggering message with the content of the membership list.

According to another advantageous refinement of the present invention, it is proposed that if there are multiple triggering messages for the at least one first process computer, a decision be made as a function of the content of the triggering messages by a majority decision as to how the faulty first process computer and/or the component are to be triggered.

Advantageously, a successful triggering of the faulty first process computer and/or the component is reported at least to the at least one sender of the triggering message.

Preferably the successful triggering of the faulty first process computer and/or the component is reported to all process computers in that the faulty first process computer is deleted from a global membership list provided in the communication system, those process computers that are connected to the communication system and are actively involved in communication via the communication system being included in the membership list.

As another way of achieving the object of the present invention, starting from the distributed safety-related system of the type defined in the preamble, it is proposed that

at least one of the additional process computers have means for determining a fault in at least one of the first process computers and means for relaying a triggering message for triggering the faulty first process computer and/or the component triggered by it via the communication system if the at least one faulty first process computer has a fault;

information be made available to the communications controller of the faulty first process computer regarding whether the sender of the triggering message is authorized to trigger the faulty first process computer;

information be made available to the communications controller of the faulty first process computer regarding whether the sender of the triggering message is connected to the communication system and is actively involved in communication via the communication system;

the communications controller of the faulty first process computer have means for deciding according to a preselectable decision-making algorithm how the faulty first process computer and/or the component are to be triggered as a function of the content of triggering messages of those senders that are authorized to trigger the faulty first process computer and are connected to the communication system and are actively involved in communication via the communication system; and

the communications controller of the faulty first process computer have means for triggering the faulty first process computer and/or the component accordingly.

According to an advantageous refinement of the present invention, it is proposed that the information regarding whether the sender of the triggering message is authorized to trigger the faulty first process computer be available in the form of a local authorization list provided in the communications controller of the at least one first process computer.

According to a preferred embodiment of the present invention, it is proposed that the information regarding whether the sender of the triggering message is connected to the communication system and is actively involved in communication via the communication system be available in the form of a global membership list provided in the communication system.

As yet another way of achieving the object of the present invention, starting from the communications controller of the type defined in the preamble, it is proposed that the communication protocol be supplemented by mechanisms which make it possible for the communications controller

to check whether one of the additional process computers which relays a triggering message for triggering at least one faulty first process computer and/or the component triggered by it via the communication system is connected to the communication system and is actively involved in communication via the communication system;

to check whether the sender of the triggering message is authorized to trigger the faulty first process computer;

to decide according to a preselectable decision-making algorithm how the first process computer and/or the component are to be triggered as a function of the content of triggering messages of those senders that are authorized to trigger the faulty first process computer and are connected to the communication system and are actively involved in communication via the communication system; and

to trigger the first process computer and/or the component accordingly.

According to an advantageous refinement of the present invention, it is proposed that the communication protocol be supplemented by mechanisms for execution of the method according to the present invention.

Finally, as yet another way of achieving the object of the present invention, starting from the communication protocol of the type defined in the preamble, it is proposed that the communication protocol be supplemented by mechanisms

to check whether one of the additional process computers which relays a triggering message for triggering at least one faulty first process computer and/or the component triggered by it via the communication system is connected to the communication system and is actively involved in communication via the communication system;

to check whether the sender of the triggering message is authorized to trigger the faulty first process computer;

to decide according to a preselectable decision-making algorithm how the first process computer and/or the component are to be triggered as a function of the content of triggering messages of those senders that are authorized to trigger the faulty first process computers and are connected to the communication system and are actively involved in communication via the communication system; and

trigger the first process computer and/or the component.

According to an advantageous refinement of the present invention, it is proposed that the communication protocol be supplemented by mechanisms for execution of the method according to the present invention.

### DRAWINGS

Additional features, possible applications and advantages of the present invention are derived from the following description of exemplary embodiments of the present invention which are illustrated in the drawing. All the features described or illustrated here, either alone or in any desired combination, constitute the object of the present invention, regardless of how they are worded in the patent claims or their reference back to a preceding claim and regardless of how they are formulated in the description or illustrated in the drawing.

FIG. 1 shows a distributed safety-related system according to the present invention in a sectional view in a preferred embodiment.

FIG. 2 shows a triggering module known from the related art as part of a distributed safety-related system.

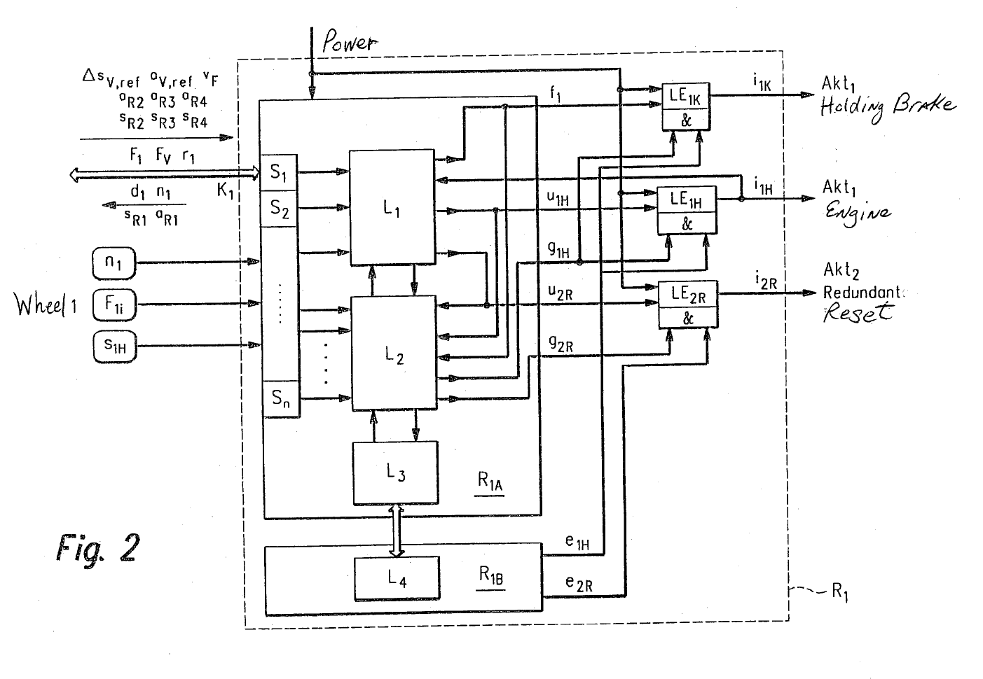

FIG. 3 shows enabling signals within a triggering module from FIG. 1.

FIG. 4 shows a shutdown protocol according to a first preferred embodiment of the method according to the present invention.

FIG. 5 shows a shutdown protocol according to a second preferred embodiment of the method according to the present invention.

### DESCRIPTION OF THE EXEMPLARY EMBODIMENTS

The method according to the present invention is explained in greater detail below on the basis of an electric brake system. However, the present invention is not limited to electric brake systems, but instead may be used for any distributed safety-related systems. The present invention allows reliable enabling of components Akt_1 in the safety-related system without the use of additional monitoring units. The functions of the monitoring units are instead assumed by additional process computers P_m of the distributed system which are present in the system anyway and have been expanded by a corresponding functionality.

For each vehicle wheel to be braked, the brake system includes a wheel module R_1, R_m. Each wheel module R_1, R_m includes a microcomputer system P_1, P_m and an enabling circuit FS_1, FS_m. Microcomputer systems P_1, P_m each include one process computer Pro_1, Pro_m and an intelligent communications controller S_1, S_m. Process computer Pro_1, Pro_m and communications controller S_1, S_m of a microcomputer system P_1, P_m may be combined on a semiconductor module (called a chip); however, they are always designed as separate, independent units. Each wheel module R_1, R_m is connected to a communication system K_1 in the form of a physical databus via a communications controller S_1, S_m. Data is transmitted over the databus according to, for example, the CAN (controller area network), the TTCAN(time-triggered CAN), the TTP/C(time-triggered protocol for class C), or the FlexRay protocol. Wheel modules R_1, R_m each control one component in the form of an actuator Akt_1, Akt_m which are designed as electric motors, for example, for actuation or release of the wheel brakes.

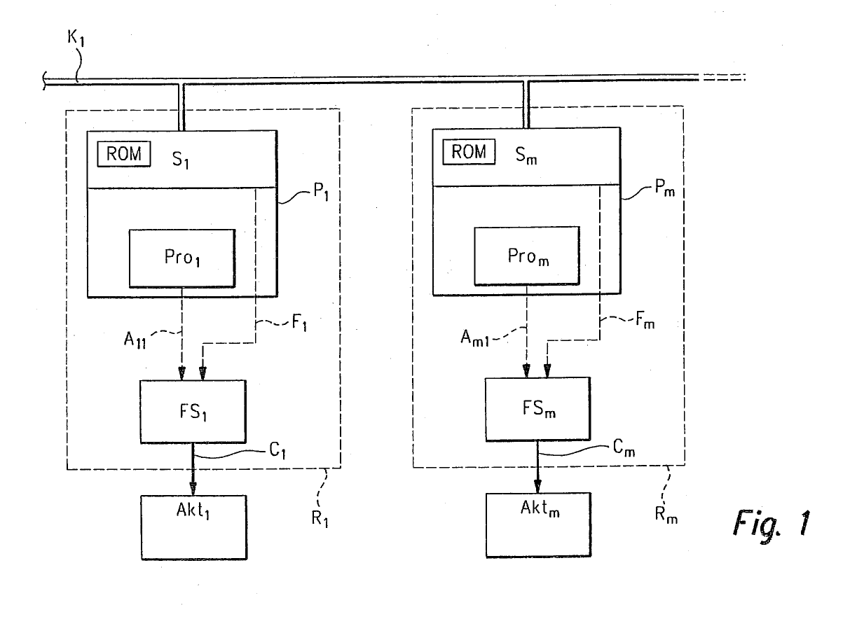

FIG. 1 shows the internal structure of two wheel modules and the signal flow taking place therein in the case of one possible embodiment of the distributed monitoring concept. The function of wheel module R_1 (more precisely, process computer Pro_1) is the triggering of actuator Akt_1 of the electric brake system. In triggering actuator Akt_1, it is important to prevent actuator Akt_1 from being triggered by a faulty triggering signal A_11 of microcomputer system P_1. This means that triggering signal A_11 should be relayed to actuator Akt_1 only when it is certain with a sufficiently high probability that it is fault-free. Triggering of actuator Akt_1 therefore includes essentially the following steps:

a) Processor Pro_1 of microcomputer system P_1 determines at least one triggering signal A_11 for actuator Akt_1 by processing a program code as a function of at least one input signal. The input signals contain information regarding the actual status of the brake system and the motor vehicle and are relayed via databus K_1 to first wheel module R_1.

b) Processors Pro_m (e.g., m=2 . . . 4) of additional microcomputer systems P_m likewise determine a logic triggering signal A_1m by processing the same program code as a function of the same input signals. This presupposes that in addition to a program code for determining triggering signals A_m1 for actuators Akt_m, the program code from processor Pro_1 must additionally be available in processors Pro_m. In the present example having a plurality of similar wheel modules R_1, R_m, this means little or no additional complexity because the program codes running on processors Pro_1, Pro_m are essentially the same. Thus, the program code, which is available anyway in processors Pro_m, may be processed together with the input signals of first wheel module R_1 to obtain logic triggering signals A_1m. This simplification applies to all distributed systems having similar triggering modules. The input signals may be relayed to microcomputer systems P_m via databus K_1. With correct functioning of process computers Pro_1, Pro_m, triggering signals A_11 and logic triggering signals A_1m are identical.

c) In process computers Pro_m of additional microcomputer systems P_m, triggering signal A_11 is compared with triggering signal A_11 determined previously in process computer Pro_1. To do so, triggering signal A_11 must be relayed via databus K_1 to additional microcomputer systems P_m. Additional microcomputer systems P_m generate status information which is transmitted via databus K_1 to first communications controller S_1 of first microcomputer system P_1. The information that must be relayed over communication system K_1 for implementation of the distributed monitoring concept includes for example one or more bits. It is conceivable for the information to be tied into the communication protocol of databus K_1 for transmission.

d) Communications controller S_1 of first microcomputer system P_1 analyzes the incoming status information and, in the event of a corresponding status (i.e., when signaling a correct functioning of process computer Pro_1), it generates an enabling signal F_1. The analysis of the status information may take place in various ways. For example, it may be a comparison, a logic link (preferably an AND link), or a majority decision of status information SF_1m.

e) Finally, the at least one triggering signal A_11 or at least one signal which depends thereon is relayed to actuator Akt_1 if the at least one enabling signal F_1 has a preselectable value. To check this, an AND link of triggering signal A_11 with enabling signal F_1 is executed in enabling circuit FS_1. If enabling signal F_1 is a logic one, triggering signal A_11 is relayed to actuator Akt_1. However, if enabling signal F_1 is logic zero, triggering signal A_11 is not relayed to actuator Akt_1.

Through the method described here, the functionality of processor Pro_1 of microcomputer system P_1 may be checked and a reliable enabling of actuator Akt_1 may be achieved. To check on processor Pro_1, mainly processors Pro_m of additional microcomputer systems P_m are used. In the same manner, however, the method according to the present invention may also be used to check on the functionality of processors Pro_m of additional microcomputer systems P_m and for reliable enabling of actuator Akt_m. Then the other processors Pro_m (not including the processor to be tested) and processor Pro_1 of first microcomputer system P_1 are used for testing. Each individual microcomputer system P_1, P_m within the security-relevant distributed brake system thus has the primary function of determining triggering signals A_11, A_m1 for actuators Akt_1, Akt_m assigned to it and also the secondary function of monitoring the functioning of the other processors in the fulfillment of their primary functions. Without the use of additional monitoring units, thus the possibility of a reliable and even redundantly effective enabling of actuators Akt_1, Akt_m is created through the distributed monitoring concept described here.

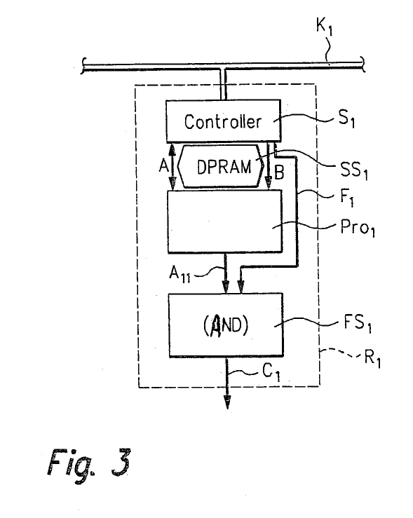

FIG. 3 shows a detail of wheel module R_1. For implementation of a secured shutdown path via communication system K_1, software interfaces SS_1 are provided between communications controller S_1 and process computer Pro_1. Interfaces SS_1 are used for setting a triggering message in the form of a shutdown vector by an additional process computer Pro_m and for interrogating the currently valid shutdown vector received via communications controller S_1.

For implementation of the distributed monitoring concept, it is also necessary to have a hardware interface which is brought by communications controller S_1 to enabling circuit FS_1. The hardware interface is used in particular to shut down actuator Akt_1 by communications controller S_1 in the event of fault situations in which process computer Pro_1 is unable to reliably read out the prevailing shutdown vector and shut down actuator Akt_1. To do so, a terminal pin F_1 which is connected to enabling circuit FS_1 via a connecting line is provided. This pin F_1 must be kept at logic 1 in the normal case (there is no shutdown command) to ensure the enabling of actuator Akt_1 by communications controller S_1. In the case when there is a shutdown command, terminal pin F_1 must be switched to logic zero on enabling circuit FS_1 to ensure the enabling.

A communication system K_1 that has already been standardized in motor vehicles today, and the bus cabling (single-wire or two-wire lines) connected to it are used as a shutdown path in the distributed monitoring concept. No explicit cabling is needed for the shutdown path between the units of the distributed system. Communication system K_1 executes a shutdown protocol which is built into the normal protocol sequence (actual sending and receiving of messages, message confirmation, and membership service). This results in a slight increased burden on the protocol computer (communications controller S_1) but it yields a significant improvement in the use of existing control units (P_1, P_m) and/or process computers (Pro_1, Pro_m). In addition, communication system K_1 makes available software and hardware interfaces SS_1, F_1 to process computers Pro_1, Pro_m to initiate and/or implement the triggering, i.e., shutdown, protocol.

In the distributed monitoring concept described above, thus an enabling circuit FS_1 is operated by process computer Pro_1 and by communications controller S_1. It is thus possible to shut down actuator Akt_1 using the shutdown mechanism described in this patent application via communication system K_1. In addition, process computer Pro_1 itself may be connected to communications controller S_1 so that process computer Pro_1 may also be shut down, e.g., by connecting it to a reset line B of process computer Pro_1.

Implementation of the secured shutdown path via communication system K_1 is possible with almost any control unit Pro_1, Pro_m which is connected with its communications controller S_1, S_m to a databus K_1. Communications controller S_1, S_m must implement the shutdown protocol in the communication protocol. The shutdown protocol and the configuration data and/or interfaces SS_1, F_1 required for this purpose are described below.

Static information regarding which microcomputer system P_m, i.e., which process computer Pro m has the authorization to shut down process computer Pro_1 assigned to communications controller S_1, is stored in communications controllers S_1. The static information is stored, for example, in a flash EPROM (erasable and programmable read-only memory) in communications controllers S_1.

This static information may be composed of the following content:

An identifier of local communications controller S_1. This is already present in some protocols, e.g., TTP/C.

A local (individual) list, including the identifiers of communications controllers S_m whose shutdown message for shutdown of local process computer Pro_1, i.e., actuator Akt_1 triggered by it, may be carried via communications controller S_1. The list is preferably limited to the number of authorized communications controllers, e.g., to three entries.

In addition, the static information must also be configured to indicate whether an authorized shutdown is to be indicated only in interface SS_1 to process computer Pro_1 or whether the shutdown message is also to be relayed over suitable wiring to enabling circuit FS_1.

The shutdown vector is a bit vector and represents the m members in the entire distributed safety-related system. A certain bit position is assigned to an identifier of a certain communications controller S_1, S_m. Two states may be represented per control unit P_1, P_m in the shutdown vector:

Zero: There is no shutdown command to the communications controller with the identifier at the corresponding bit position.

One: There is a shutdown command for the communications controller corresponding to the bit position.

For reasons of limited bandwidth or limited number of protocol data (control data for the protocol sequence which is sent jointly with the useful data in a message package over communication system K_1), the shutdown vector may be shortened. Then only selected control units P_1, P_m are represented in the shutdown vector.

For the implementation of the distributed monitoring concept according to the present invention, information as to whether the sender of a shutdown vector is connected to communication system K_1 and is actively involved in communication over communication system K_1 is also accessed. This information is made available by many communication protocols as standard. This functionality is also referred to as membership service in the communication protocols. Then this information is contained in the membership information. Then the membership/activity of a process computer Pro_1, Pro_m is determined in a decision-making process involving all active communication members via a mechanism of message confirmation. After a certain number of decision-making rounds, the membership information is stable, i.e., it is recognized as valid by all members.

If, through this decision, a control unit P_1, P_m is designated as inactive, this control unit must no longer be actively involved in communication. Responsible process computer Pro_1, Pro_m will recognize this state and must take measures to make communications controller S_1, S_m assigned to it active again (restart and resynchronization). The mechanism for determining the active members (membership) is executed continuously and is part of the actual communication protocol. The membership information is available in communication system K_1 in the form of a membership vector Me.

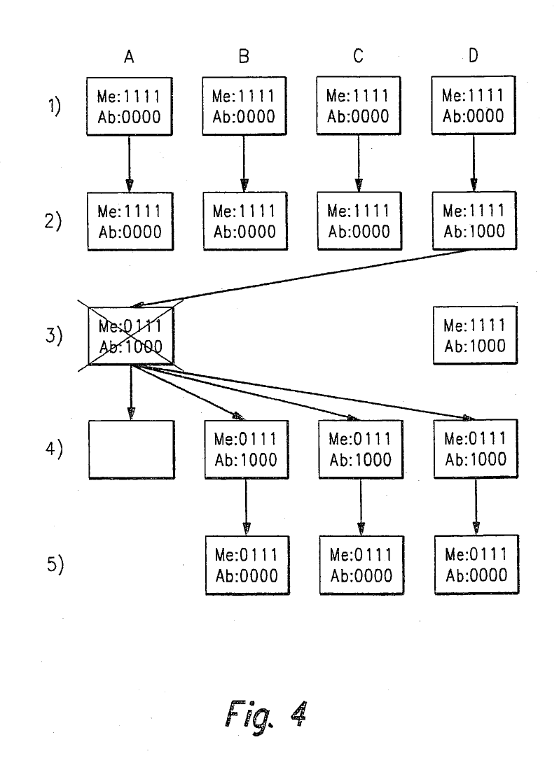

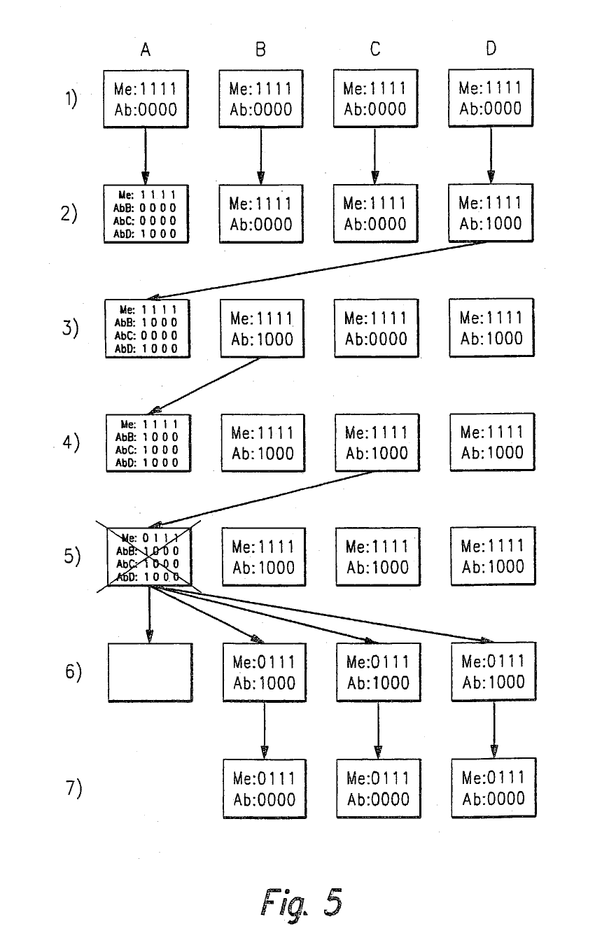

The initial situation for implementation of the method according to the present invention is an active distributed system having functioning members (communications controllers S_1, S_m and their control units P_1, P_m, i.e., process computers Pro_1, Pro_m). Membership information Me is thus set to “1” for each member and there is no request for shutdown (shutdown vector Ab). This initial situation is illustrated in step 1) in FIGS. 4 and 5 for a distributed system having four members A, B, C, D. FIG. 4 pertains to a shutdown protocol having only one authorized member (member A may be shut down only by member D) whereas FIG. 5 shows a shutdown protocol having three authorized members and an absolute majority (member A is shut down when at least two of the three additional members B, C, and D advocate shutdown of member A).

Shutdown vector Ab represents a shutdown command of an authorized control unit P_m for a certain control unit P_1 as soon as the bit position for this control unit P_1 is set to “1.” The shutdown vector is coded and sent by the communication protocol at sender P_m with the other control data of a message (see step 2) in FIGS. 4 and 5).

Communication system K_1 is based on multicast messages. It may thus be assumed that each active control unit P_1, P_m is receiving all messages sent and recognized as fault-free and then starts local protocol mechanisms. Special cases in which the correctness of a message is decided only after a certain number of additional sending operations (e.g., in the case of TTP/C) must be handled separately. This special case means that even the shutdown vector received is to be considered as invalid until this final decision. Communications controller S_1 derives the information of shutdown vector Ab from the protocol data received.

If on the basis of the protocol implementation the identifier of sender P_m has been clarified, then the check on authorization may take place at receiver S_1. Receiver S_1 recognizes the identifier of sender P_m of the message on the basis of the relationship of the sending point in time, the message identifier and the static information regarding the shutdown authorization. If the identity of sender P_m has not been ascertained unambiguously, the identifier of sender P_m must also be transmitted in addition to shutdown vector Ab.

In the case of the shutdown protocol from FIG. 4, a bit position which corresponds to the identifier of member A has been set in shutdown vector Ab of member D. Member D has been entered as being authorized for shutdown in the local authorization list of member A. For this reason, the process computer is shut down in step 3) and/or the actuator of member A, triggered by the process computer, is shut down.

Communications controller S_1 sets the status of shutdown vector Ab in software interface SS_1 to the current status (see step 3) in FIG. 4 and SS_1 in FIG. 3). Communications controller S_1 sets the level for shutdown on the terminal pin provided on the hardware interface to initiate the shutdown of the actuator via enabling circuit FS_1 (see step 3) in FIG. 4 and signal F_1 and signal B in FIG. 3). Communications controller S_1 changes to the passive state, i.e., it is no longer involved in communication via communication system K_1. As a result of this measure, it is signaled to the other members B, C, and D that the entire node (including the control unit, the actuator, the sensor, and the communications controller of member A) is no longer available. This causes member A to be deleted from membership vector Me of the other members B, C, D in the distributed system (see step 4) in FIG. 4) in that the corresponding bit position is set to “0.” Due to the lack of a membership entry of the shutdown member A, sender D of the shutdown vector Ab receives confirmation regarding the success of its shutdown command. It is no longer necessary to reset it in the shutdown vector Ab (see step 5) in FIG. 4). The bit position corresponding to member A is set in shutdown vector Ab until there is confirmation of the shutdown command.

In the shutdown protocol from FIG. 5, the shutdown of a member A takes place only when the bit position set in shutdown vector Ab corresponds to the identifier of member A and there is an agreement among the authorized members B, C, and D concerning the shutdown of member A, in which case all three members B, C, D are entered in the local authorization list as being authorized for shutdown of member A.

To implement this, shutdown vectors Ab of the various members B, C, D must be collected. Shutdown vector Ab of a certain member B, C or D may be collected only when member B, C, or D is characterized as being active in the membership vector Me of the communication protocol (see steps 3 through 5 in FIG. 5). This prevents the situation from occurring whereby a shutdown of a member A would be necessary but one of members B, C, D itself is not active and thus shutdown of member A is prevented because the shutdown command of inactive member B, C, or D is missing.

After all authorized members B, C, D have relayed their shutdown vectors AbB, AbC, AbD, the coordination procedure is initiated according to a preselectable decision-making algorithm. For the coordination in the present case, the absolute majority of active authorized members B, C, D is selected. Another decision-making algorithm such as a two-of-three selection may also be implemented. The choice of the decision-making algorithm to be used may be set with the configuration in communications controller S_1, e.g., a selection of an absolute majority, a two-of-three selection or an at least one semantic. In the exemplary embodiment illustrated in FIG. 5, member A is thus shut down only when all authorized members B, C, D have supported a shutdown of member A via their particular shutdown vectors AbB, AbC, AbD (see step 5) in FIG. 5). Communications controller S_1 has the status of shutdown vector Ab in the software interface at the current status (see step 5) in FIG. 5 and SS_1 in FIG. 3). Communications controller S_1 sets the level for shutdown on the terminal pin provided in the hardware interface in order to initiate the shutdown via enabling circuit FS_1 (step 5) in FIG. 5 and signal F_1 and signal B in FIG. 3). Communications controller S_1 changes to its passive state, i.e., it is no longer involved in communication. As a result of this measure, it is signaled to the other members B, C, and D that the entire node including the control unit, the actuator, the sensor, and the communications controller are no longer available. This causes member A to be deleted from membership vector Me of the other members B, C, D in the distributed system (see step 6) in FIG. 5). Due to the lack of a membership entry of the shutdown member A, the senders (members B, C, D) of shutdown vector Ab receive confirmation of the success of the shutdown command. It is no longer necessary to reset the bit position in shutdown vector Ab corresponding to member A (see step 7) in FIG. 5). Each sender Pro_m of a shutdown vector Ab sets the bit position corresponding to member A in its shutdown vector Ab until the confirmation of successful shutdown of member A which is to be shut down has been relayed by the lack of the corresponding member A in membership vector Me.

What is claimed is:

1. A method for operating a distributed safety-related system, in particular an X-by-wire system in a motor vehicle, comprising at least one first process computer (Pro_1) for triggering a component (Akt_1) of the system and at least one additional process computer (Pro_m), the process computers (Pro_1, Pro_m) each being connected via a communications controller (S_1, S_m) to a communication system (K_1) and the functionality of the at least one first process computer (Pro_1) being checked by the at least one additional process computer (Pro_m), characterized by the following steps:
at least one of the additional process computers (Pro_m) which has determined a fault in at least one of the first process computers (Pro_1), relays a triggering message (Ab_m) via the communication system (K_1) for triggering the faulty first process computer (Pro_1) or the component (Akt_1) triggered by it;
a check is performed to determine whether the sender of the triggering message (Ab_m) is authorized to trigger the faulty first process computer (Pro_1);
a check is performed to determine whether the sender of the triggering message (Ab_m) is connected to the communication system (K_1) and is actively involved in communication via the communication system (K_1);
a decision is made according to a preselectable decision-making algorithm as to how the faulty first process computer (Pro_1) and/or the component (Akt_1) are to be triggered as a function of the content of triggering messages (Ab_m) of those senders that are authorized to trigger the faulty first process computer (Pro_1) and are connected to the communication system (K_1) and are actively involved in communication via the communication system (K_1); and
the faulty first process computer (Pro_1) and/or the component (Akt_1) are triggered accordingly.

2. The method as recited in claim 1, wherein shutdown of the faulty first process computer (Pro_1) and/or the component (Akt_1) is achieved through the triggering message.

3. The method as recited in claim 1 or 2, wherein a local authorization list (Be_1) is provided in the communications controller (S_1) of the at least one first process computer (Pro_1) on the basis of which a check is performed to determine whether the sender of the triggering message (Ab_m) is authorized to trigger the faulty first process computer (Pro_1) by comparing an identifier of the sender of the triggering message (Ab_m) with the content of the authorization list (Be_1).

4. The method as recited in one of claims 1 through 3, wherein a global membership list (Me) is provided in the communication system (K_1) on the basis of which a check is performed to determine whether the sender of the triggering message (Ab_m) is connected to the communication system (K_1) and is actively involved in communication via the communication system (K_1) by comparing an identifier of the sender of the triggering message (Ab_m) with the content of the membership list (Me).

5. The method as recited in one of claims 1 through 4, wherein if there are multiple triggering messages (Ab_m) for the at least one first process computer (Pro_1) a decision is made as a function of the content of the triggering messages (Ab_m) by a majority decision as to how the faulty first process computer (Pro_1) and/or the component (Akt_1) are to be triggered.

6. The method as recited in one of claims 1 through 5, wherein a successful triggering of the faulty first process computer (Pro_1) and/or the component (Akt_1) is reported at least to the at least one sender of the triggering message (Ab_m).

7. The method as recited in claim 6, wherein the successful triggering of the faulty first process computer (Pro_1) and/or the component (Akt_1) is reported to all process computers (Pro_m) in that the faulty first process computer (Pro_1) is deleted from a global membership list (Me) provided in the communication system (K_1), those process computers (Pro_1, Pro_m) that are connected to the communication system (K_1) and are actively involved in communication via the communication system (K_1) being included in the membership list (Me).

8. A distributed safety-related system, in particular an X-by-wire system in a motor vehicle, comprising at least one first process computer (Pro_1) for triggering a component (Akt_1) of the system and at least one additional process computer (Pro_m), the process computers (Pro_1, Pro_m) each being connected via a communications controller (S_1, S_m) to a communication system (K_1), and monitoring of the functionality of the at least one first process computer (Pro_1) being performed by the at least one additional process computer (Pro_m), wherein
at least one of the additional process computers (Pro_m) has means for determining a fault in at least one of the first process computers (Pro_1) and means for relaying a triggering message (Ab_m) for triggering the faulty first process computer (Pro_1) and/or the component (Akt_1) triggered by it via the communication system (K_1) if the at least one faulty first process computer (Pro_1) has a fault;
information is made available to the communications controller (S_1) of the faulty first process computer (Pro_1) regarding whether the sender of the triggering message (Ab_m) is authorized to trigger the faulty first process computer (Pro_1);
information is made available to the communications controller (S_1) of the faulty first process computer (Pro_1) regarding whether the sender of the triggering message (Ab_m) is connected to the communication system (K_1) and is actively involved in communication via the communication system (K_1);
the communications controller (S_1) of the faulty first process computer (Pro_1) has means for deciding according to a preselectable decision-making algorithm how the faulty first process computer (Pro_1) and/or the component (Akt_1) are to be triggered as a function of the content of triggering messages (Ab_m) of those senders that are authorized to trigger the faulty first process computer (Pro_1) and are connected to the communication system (K_1) and are actively involved in communication via the communication system (K_1); and
the communications controller (S_1) of the faulty first process computer (Pro_1) has means for triggering the faulty first process computer (Pro_1) and/or the component (Akt_1) accordingly.

9. The distributed system as recited in claim 8, wherein the information regarding whether the sender of the triggering message (Ab_m) is authorized to trigger the faulty first process computer (Pro_1) is available in the form of a local authorization list (Be_1) provided in the communications controller (S_1) of the at least one first process computer (Pro_1).

10. The distributed system as recited in claim 8 or 9, wherein the information regarding whether the sender of the triggering message (Ab_m) is connected to the communication system (K_1) and is actively involved in communication via the communication system (K_1) is available in the form of a global membership list (Me) provided in the communication system (K_1).

11. A communications controller (S_1) for connecting at least one first process computer (Pro_1) and at least one additional process computer (Pro_m) to a communication system (K_1) of a distributed safety-related system, in particular an X-by-wire system in a motor vehicle, the at least one first process computer (Pro_1) being used for triggering a component (Akt_1) of the distributed system and a communication protocol running on the communications controller (S_1) for implementing a data transfer between the process computers (Pro_1, Pro_m) and the communication system (K_1), wherein the communication protocol is supplemented by mechanisms which make it possible for the communications controller (S_1)
to check whether one of the additional process computers (Pro_m) which relays a triggering message (Ab_m) for triggering at least one faulty first process computer (Pro_1) and/or the component (Akt_1) triggered by it via the communication system (K_1) is connected to the communication system (K_1) and is actively involved in communication via the communication system (K_1);
to check whether the sender of the triggering message (Ab_m) is authorized to trigger the faulty first process computer (Pro_1);
to decide according to a preselectable decision-making algorithm how the first process computer (Pro_1) and/or the component (Akt_1) are to be triggered as a function of the content of triggering messages (Ab_m) of those senders that are authorized to trigger the faulty first process computer (Pro_1) and are connected to the communication system (K_1) and are actively involved in communication via the communication system (K_1); and
to trigger the first process computer (Pro_1) and/or the component (Akt_1) accordingly.

12. The communications controller (S_1) as recited in claim 11, wherein the communication protocol is supplemented by mechanisms for execution of a method as recited in one of claims 2 through 7.

13. A communication protocol for a communication system (K_1) of a distributed safety-related system, in particular an X-by-wire system in a motor vehicle, the distributed system including at least one first process computer (Pro_1) for triggering a component (Akt_1) of the distributed system and at least one additional process computer (Pro_m), and the process computers (Pro_1, Pro_m) each being connected to the communication system (K_1) via a communications controller (S_1, S_m), the communication protocol for implementing a data transfer between the process computers (Pro_1, Pro_m) and the communication system (K_1) running on the communications controllers (S_1, S_m), wherein the communication protocol is supplemented by a mechanism:
to check whether one of the additional process computers (Pro_m), which relays a triggering message (Ab_m) for triggering at least one faulty first process computer (Pro_1) and/or the component (Akt_1) triggered by it via the communication system (K_1), is connected to the communication system (K_1) and is actively involved in communication via the communication system (K_1);
to check whether the sender of the triggering message (Ab_m) is authorized to trigger the faulty first process computer (Pro_1);
to decide according to a preselectable decision-making algorithm how the first process computer (Pro_1) and/or the component (Akt_1) are to be triggered as a function of the content of triggering messages (Ab_m) of those senders that are authorized to trigger the faulty first process computer (Pro_1) and are connected to the communication system (K_1) and are actively involved in communication via the communication system (K_1); and
to trigger the first process computer (Pro_1) and/or the component (Akt_1) accordingly.

14. The communication protocol as recited in claim 13, wherein the communication protocol is supplemented by mechanisms for execution of a method as recited in one of claims 2 through 7.
